(19) United States
(12) Patent Application Publication
(10) Pub. No.: US 2014/0181334 A1
(43) Pub. Date: Jun. 26, 2014

(54) SYSTEM AND METHOD FOR DETERMINATION OF LATENCY TOLERANCE

(71) Applicants: Jaya L. Jeyaseelan, Cupertino, CA (US); Jim Walsh, Santa Clara, CA (US); Neil Songer, Santa Clara, CA (US); Barnes Cooper, Tigard, OR (US)

(72) Inventors: Jaya L. Jeyaseelan, Cupertino, CA (US); Jim Walsh, Santa Clara, CA (US); Neil Songer, Santa Clara, CA (US); Barnes Cooper, Tigard, OR (US)

(21) Appl. No.: 13/726,481

(22) Filed: Dec. 24, 2012

(51) Int. Cl. G06F 13/10

(52) U.S. Cl. CPC G06F 13/10
USPC 710/18

(57) ABSTRACT

Particular embodiments described herein can offer a method that includes receiving first link state information associated with a first device, determining, by a processor, an upward latency tolerance based, at least in part, on the first link state information, and providing the upward latency tolerance to a power management controller.

### TECHNICAL FIELD

Embodiments described herein generally relate to determining a latency tolerance in a processor environment.

### BACKGROUND

As electronic apparatuses become more complex and ubiquitous in the everyday lives of users, more and more diverse requirements are placed upon them. For example, many electronic apparatuses can operate on battery power, thus allowing users to operate these devices in many different circumstances. In addition, as capabilities of electronic apparatuses become more extensive, many users have become reliant on the enhanced performance such capabilities provide. As these aspects of electronic apparatuses have evolved, there has become an increasing need for reducing power consumption. However, under many circumstances, reducing power consumption may sacrifice performance. Therefore, it will be highly beneficial for a user to be able to have the desired performance when it matters the most to them, and optimizing power performance during circumstances where performance may be less important to them. One possible area that may be advantageous for such improvements may pertain to the communication of latency concerns regarding devices of an electronic apparatus.

### BRIEF DESCRIPTION OF THE DRAWINGS

Embodiments are illustrated by way of example and not by way of limitation in the FIGURES of the accompanying drawings, in which like references indicate similar elements and in which:

FIG. 1 is a block diagram illustrating components associated with providing latency tolerance according to at least one example embodiment;

FIG. 2A is a table showing upward latency tolerance in relation to SATA link state according to at least one example embodiment;

FIG. 2B is a table showing upward latency tolerance in relation to SATA link state and SATA commands outstanding according to at least one example embodiment;

FIG. 2C is a table showing upward latency tolerance in relation to USB link state according to at least one example embodiment;

FIG. 2D is a table showing upward latency tolerance in relation to USB link state and endpoints according to at least one example embodiment;

FIG. 3 is a flow diagram showing a set of operations for providing an upward latency tolerance according to at least one example embodiment;

FIG. 4 is another flow diagram showing a set of operations for providing an upward latency tolerance according to at least one example embodiment;

FIG. 5 is still another flow diagram showing a set of operations for providing an upward latency tolerance according to at least one example embodiment;

FIG. 6 is yet another flow diagram showing a set of operations for providing an upward latency tolerance according to at least one example embodiment;

FIG. 7 is a simplified block diagram associated with an example ARM ecosystem system on chip (SOC) of the present disclosure; and

FIG. 8 is a simplified block diagram illustrating example logic that may be used to execute activities associated with the present disclosure.

The FIGURES of the drawings are not necessarily drawn to scale or proportion, as their dimensions, arrangements, and specifications can be varied considerably without departing from the scope of the present disclosure.

### DETAILED DESCRIPTION OF EXAMPLE EMBODIMENTS

The following detailed description sets forth example embodiments of apparatuses, methods, and systems relating to providing a power savings in a processor environment. Features such as structure(s), function(s), and/or characteristic(s), for example, are described with reference to one embodiment as a matter of convenience; various embodiments may be implemented with any suitable one or more of the described features. It should be understood that terms such as “first”, “second”, etc. are merely used for differentiation purposes, and do not denote any sequential relationship, chronological relationship, and/or the like.

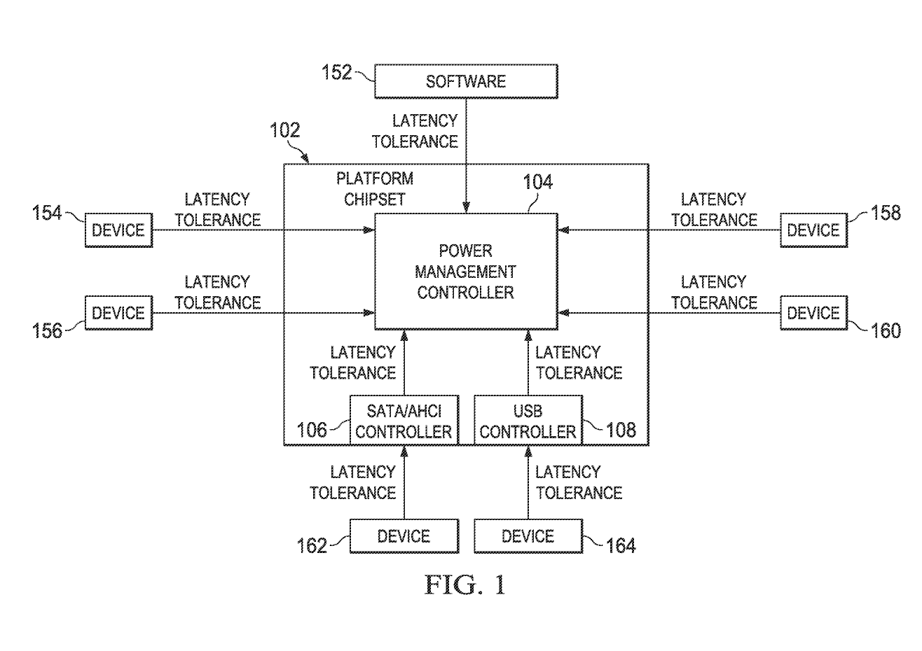

FIG. 1 is a block diagram illustrating components associated with providing latency tolerance according to at least one example embodiment. The examples of FIG. 1 are merely examples of components associated with determining latency tolerance, and do not limit the scope of the claims. For example, operations attributed to a component may vary, number of components may vary, composition of a component may vary, and/or the like. For example, in some example embodiments, operations attributable to one component of the example of FIG. 1 may be allocated to one or more other components.

In electronic devices, there is often a tradeoff between power saving and performance. For example, lesser power saving states may have longer associated latency times than higher power saving states. In some circumstances, it may be desirable to avoid performance degradation associated with power saving. For example, if a device performs an operation that would benefit from the use of another device within a certain period of time, it may be desirable to influence power saving measures such that the power saving still allows the device to use the other device without undue delay. For example, a hard drive may benefit from avoiding circumstances where a processor is unable to receive information associated with a read operation due to power saving recovery. The amount of time in which a power saving feature should avoid interference with a device may be referred to as a latency tolerance. For example, if a device benefits from avoiding unavailability of another device after a specified period of time, the latency tolerance for the device may indicate a value of the specified period of time.

The example of FIG. 1 illustrates software 152 and devices 154-164 in communication with platform chipset 102. Platform chipset 102 may comprise a power management controller 104. Power management controller 104 may be in communication with one or more controllers and/or one or more devices. Even though the controllers of the example of FIG. 1 include serial advanced technology attachment/advanced host controller interface (SATA/AHCI) controller 106 and universal serial bus (USB) controller 108, the controllers comprised by platform chipset 102 may vary. For example, FIG. 1 illustrates devices 154-160 in direct communication with power management controller 104. However, in at least one example embodiment there may be an intermediary controller between power management controller 104 and one or more of devices 154-160, similar as described regarding SATA/AHCI controller 106 and USB controller 108.

In at least one example embodiment, a device, such as device 164, sends information indicating a latency tolerance to a controller, such as USB controller 164. In such embodiments, the controller may receive information indicating the latency tolerance. In at least one embodiment, a controller, such as SATA/AHCI controller 106, sends information indicating a latency tolerance to power management controller 104. In at least one embodiment, a device, such as device 158, may send information indicating latency tolerance associated with the device to power management controller 104. Therefore, power management controller 104 may receive information indicating the latency tolerance.

Latency tolerance information provided to another component may be referred to as an upward latency tolerance. An upward latency tolerance may be provided to a component so that a device, a set of devices, a controller, a set of controllers, a platform, a set of platforms, and/or the like, may inform another component of latency tolerance associated with other components with which the component communicates. For example, a component may determine an upward latency tolerance and provide the upward latency tolerance to another component. In the example of FIG. 1, USB controller 108 receives a latency tolerance from device 164. From the perspective of device 164, the latency tolerance sent by device 164 is an upward latency tolerance. In such an example, power management controller 104 receives a latency tolerance from USB controller 108. From the perspective of USB controller 108, the latency tolerance sent to power management controller 104 is an upward latency tolerance.

In at least one example embodiment, a controller, such as SATA/AHCI controller 106, is in communication with one or more devices, such as device 162. In such an embodiment, the controller may receive latency tolerance from each device with which the controller is in communication. In other words, the received latency tolerance may represent at least one device. The controller may determine a latency tolerance based on the received latency tolerance of the devices with which the controller is connected. For example, the controller may determine the latency tolerance to be the lowest value indicated by the reported latency tolerances. The controller may perform determination of the latency tolerance in response to receiving the reported latency tolerance. In other words, the device may cause the controller to determine the latency tolerance associated with the one or more devices by sending the latency tolerance to the controller. For example, if USB controller 108 is in communication with device 164 and other devices, device 164 may cause USB controller 108 to determine latency tolerance for device 164 and the other devices by sending a latency tolerance to USB controller 108.

In at least one example embodiment, power management controller 104 receives latency tolerance from each controller with which the controller, such as USB controller 108, is in communication. For at least the reason that each controller may be in communication with one or more devices, the received latency tolerance from a controller may represent one or more devices. Power management controller 104 may determine a latency tolerance based on the received latency tolerance of the controllers with which power management controller 104 is in communication. The latency tolerance determined by power management controller 104 may be referred to as the platform latency tolerance. The platform latency tolerance represents a latency tolerance associated with the collection of devices in communication with the controllers with which power management controller 104 is in communication. For example, power management controller 104 may determine the platform latency tolerance to be the lowest value indicated by the received latency tolerances of the controllers. Power management controller 104 may perform determination of the platform latency tolerance in response to receiving the latency tolerance. In other words, a controller, such as SATA/AHCI controller 106, may cause power management controller 104 to determine the platform latency tolerance associated with the one or more devices by providing an upward latency tolerance to power management controller 104. For example, USB controller 108 may cause power management controller 104 to determine the platform latency tolerance by sending an upward latency tolerance to power management controller 104.

There may be circumstances where at least one device does not send a latency tolerance to a controller. For example, the device may not support communication of a latency tolerance, a protocol used for communication between the device and the controller may not support communication of latency tolerance, and/or the like. In another example, even though the device may be capable of sending a latency tolerance, the sending may be delayed. Therefore, in such circumstances, there may be no latency tolerance received from a device. It may be desirable to determine a latency tolerance associated with such a device in the absence of a reported latency tolerance.

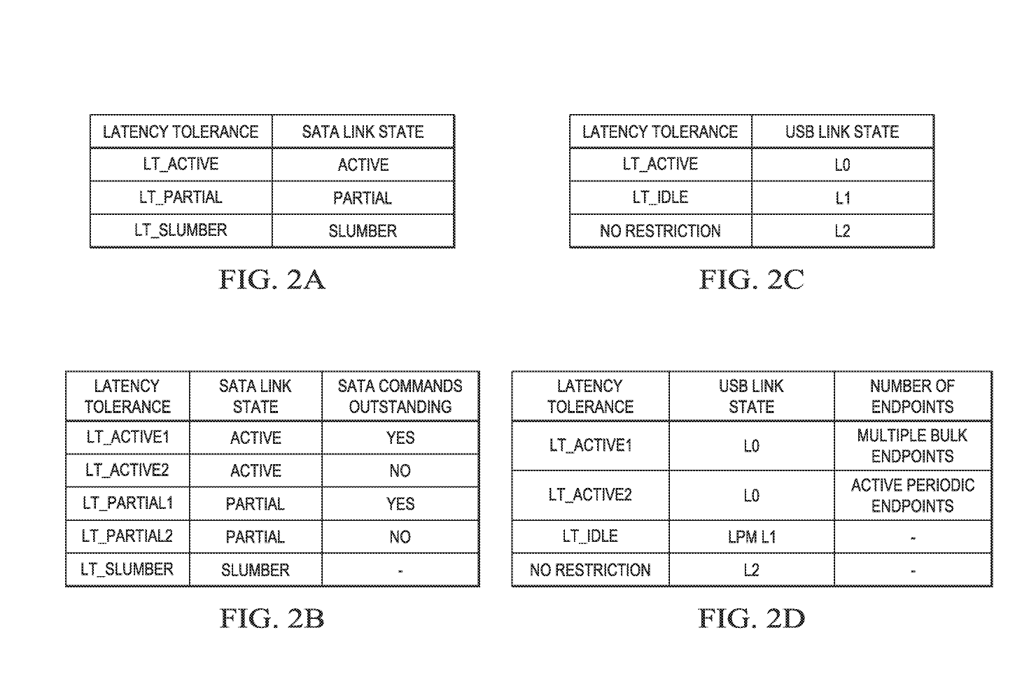

FIGS. 2A-2D are tables showing upward latency tolerance in relation to link state according to at least one example embodiment. The examples of FIGS. 2A-2D are merely examples of relationships between link state and upward latency tolerance, and do not limit the scope of the claims. For example, number of link states may vary, number of upward latency tolerances may vary, labels for upward latency tolerances may vary, and/or the like.

In the absence of receiving a latency tolerance from a device, a controller may determine a latency tolerance, to associate with the device, based, at least in part, on a link state of the device. In at least one example embodiment, link state information relates to information that indicates a power management status associated with a connection between components. For example, link state information may relate to link power management information provided by a USB standard, such as the USB 2.0 Link Power Management Addendum. In another example, link state information may relate to power management interface information, such as described in the SATA 3.0 Specification. Even though USB and SATA are discussed, it should be understood that USB and SATA are merely examples of protocols that may be utilized, and therefore does not serve to limit the claims in any way. For example, link state information associated with a different protocol may be utilized.

The controller may infer latency tolerance based on link state information. For example, link state information may indicate a power savings mode that a device and/or interface has entered. Under such circumstances, there may be a recovery time associated with the power savings mode. Therefore, a latency tolerance greater than or equal to the recovery time associated with the power savings mode may be determined. In an example embodiment, deeper link power savings modes are associated with higher latency tolerance values. For example, a longer power saving recovery time may correspond to a larger latency tolerance.

The latency tolerance may be determined based, at least in part, on the link state information by way of calculation, association with a predefined value, and/or the like. For example, determination of latency tolerance may comprise performing an algorithm for determining latency tolerance based, at least in part, on link state information. In another example, determination of latency tolerance may comprise retrieving a predetermined latency tolerance value associated with a particular link state value. In another example, determination of latency tolerance may comprise retrieving a predetermined value associated with a particular link state value, performing an algorithm for determining latency tolerance based, at least in part, on the predetermined latency tolerance value. The predetermined value may be set prior to operation, during operation, and/or the like. For example, the predetermined value may be set in a non-modifiable storage and/or in a modifiable storage. The predefined value may be set by the manufacturer of the apparatus, for example a manufacturer of platform chipset 102. The predefined value may be set by a manufacturer that utilizes the apparatus, such as an original equipment manufacturer (OEM). The predefined value may be programmable by basic input/output software (BIOS). The determined latency tolerance may be utilized as an upward latency tolerance.

FIG. 2A is a table showing upward latency tolerance in relation to SATA link state according to at least one example embodiment. In the example of FIG. 2A, there are three SATA link states; active, partial, and slumber. In at least one example embodiment, active link state relates to a link state where the device is ready to send and receive information. In at least one example embodiment, partial link state relates to the device being in a reduced power mode, which is associated with more power consumption than slumber link state. In at least one example embodiment, slumber link state relates to the device being in a reduced power mode, which is associated with less power consumption than partial link state. In the example of FIG. 2A, latency tolerances are represented by LT_Active, LT_Partial, and LT_Slumber. These representations of latency tolerances may be predetermined values, for example a variable, a constant, an enumeration, and/or the like. In the example of FIG. 2A, LT_Active corresponds to a SATA link state of active, LT_Partial corresponds to a SATA link state of partial, and LT_Slumber corresponds to a SATA link state of slumber. In at least one example embodiment, a value associated with LT_Slumber is larger than a value associated with LT_Partial, and a value associated with LT_Partial is larger than a value associated with LT_Active.

FIG. 2B is a table showing upward latency tolerance in relation to SATA link state and SATA commands outstanding according to at least one example embodiment. In at least one example embodiment, SATA commands outstanding relates to whether or not there are any SATA commands that are being executed by a device, pending for execution on a device, and/or the like. For example, a value of yes in the table of FIG. 2B may indicate that there is at least one SATA command being executed by the device, that there is at least one SATA command pending to be executed on the device, and/or the like. In another example, a value of no in the table of FIG. 2B may indicate that there is not a SATA command being executed by the device, that there is not a SATA command pending to be executed on the device, and/or the like. Information indicating SATA commands may comprise information indicating that at least one SATA command is being awaited, information indicating absence of waiting for at least one SATA command, and/or the like.

In the example of FIG. 2B, there are three SATA link states; active, partial, and slumber, similar as described regarding FIG. 2A. In the example of FIG. 2B, latency tolerances are represented by LT_Active1, LT_Active2, LT_Partial1, LT_Partial2, and LT_Slumber. These representations of latency tolerances may be predetermined values, for example a variable, a constant, an enumeration, and/or the like. In the example of FIG. 2B, LT_Active1 corresponds to a SATA link state of active with outstanding SATA commands, LT_Active2 corresponds to a SATA link state of active with no outstanding SATA commands, LT_Partial1 corresponds to a SATA link state of partial with outstanding SATA commands, LT_Partial2 corresponds to a SATA link state of partial with no outstanding SATA commands, and LT_Slumber corresponds to a SATA link state of slumber. In at least one example embodiment, a value associated with LT_Slumber is larger than a value associated with LT_Partial1, and a value associated with LT_Partial1 is larger than a value associated with LT_Active1. In at least one example embodiment, a value associated with LT_Slumber is larger than a value associated with LT_Partial2, and a value associated with LT_Partial2 is larger than a value associated with LT_Active2. In at least one embodiment, a value associated with LT_Partial1 is larger than a value associated with LT_Active2. In at least one example embodiment, a value associated with LT_Active2 is larger than a value associated with LT_Partial1.

Circumstances where there are no outstanding SATA commands may indicate that the device is less active. Therefore, an apparatus may determine an upward latency tolerance based, at least in part, on information indicating SATA commands associated with the device. For example, an apparatus may increase the upward latency tolerance under circumstances where the information indicating SATA commands indicates no outstanding SATA commands. Additionally or alternatively, an apparatus may decrease the upward latency tolerance under circumstances where the information indicating SATA commands indicates no outstanding SATA commands. In at least one example embodiment, a value associated with LT_Active2 is larger than a value associated with LT_Active1. In at least one example embodiment, a value associated with LT_Partial2 is larger than a value associated with LT_Partial1.

FIG. 2C is a table showing upward latency tolerance in relation to USB link state according to at least one example embodiment. In the example of FIG. 2C, there are three USB link states that relate to USB link power management (LPM) states as specified by the USB Specifications; L0, L1, and L2. In at least one example embodiment, L0 link state relates to a link state where the device is ready to send and receive information. The L0 state may be referred to as an on state. In at least one example embodiment, L1 state relates to the device being in a reduced power mode, which is associated with more power consumption than L2 link state. In at least one example embodiment, L2 link state relates to the device being in a reduced power mode, which is associated with less power consumption than L1 link state. In the example of FIG. 2C, latency tolerances are represented by LT_Active, LT_Idle, and No Restriction. These representations of latency tolerances may be predetermined values, for example a variable, a constant, an enumeration, and/or the like. In the example of FIG. 2C, LT_Active corresponds to a USB link state of L0, LT_Idle corresponds to a USB link state of L1, and No Restriction corresponds to a USB link state of L2. In at least one embodiment, a latency tolerance indicating no restriction indicates that no latency tolerance restrictions apply. In other words, when determining power savings modes, the device does not need any consideration regarding latency tolerance. In at least one example embodiment, a value associated with LT_Idle is larger than a value associated with LT_Active.

In at least one example embodiment, LT_Idle relates to a value that has been negotiated with devices. For example, a USB controller, such as USB controller 108, may poll attached devices to determine a value for LT_Idle. Such a value for LT_Idle may be based on the smallest latency tolerance value that will satisfy the operational constraints of each device attached to the USB controller.

FIG. 2D is a table showing upward latency tolerance in relation to USB link state and endpoint information according to at least one example embodiment. In at least one example embodiment, endpoint information relates to type of endpoint associated with one or more devices, number of endpoints associated with one or more devices, and/or the like. In at least one example embodiment, the controller may characterize the endpoint information based, at least in part, on the most restrictive endpoint information of the devices. For example, if the endpoint information indicates a bulk endpoint and an interrupt endpoint, the controller may characterize the endpoint information as indicating bulk endpoints. This characterization may be based, at least in part, on presumption and/or determination that a bulk endpoint is associated with lower latency tolerance than an interrupt endpoint. In the example of the table of FIG. 2D, a value of bulk endpoint in the table may indicate that there is at least one bulk endpoint, that the most demanding endpoint type present is a bulk endpoint, and/or the like. In another example, a value of periodic endpoint in the table of FIG. 2D may indicate that there is at least one periodic endpoint, that the most demanding endpoint type present is a periodic endpoint, and/or the like. A periodic endpoint may relate to an Isochronous endpoint. Even though the example table of FIG. 2D relates to bulk endpoints and periodic endpoints, other endpoints may be considered.

In the example of FIG. 2D, there are three USB link states; L0, L1, and L2, similar as described regarding FIG. 2C. In the example of FIG. 2D, latency tolerances are represented by LT_Active1, LT_Active2, LT_Idle, and no restriction. These representations of latency tolerances may be predetermined values, for example a variable, a constant, an enumeration, and/or the like. In the example of FIG. 2D, LT_Active1 corresponds to a USB link state of L0 with bulk endpoint indicated by the endpoint information, and LT_Active2 corresponds to a USB link state of L0 with periodic endpoint indicated by the endpoint information. In the example of FIG. 2D, LT_Idle corresponds to a USB link state of L1 absent consideration of endpoint information, and no restriction corresponds to a USB link state of L2 absent consideration of endpoint information. In at least one example embodiment, a value associated with LT_Idle is larger than a value associated with LT_Active1. In at least one example embodiment, a value associated with LT_Idle is larger than a value associated with LT_Active2.

Circumstances where there are periodic endpoints may indicate that the device is less active than circumstances where there are bulk endpoints. Therefore, an apparatus may determine an upward latency tolerance based, at least in part, on endpoint information associated with the device. For example, an apparatus may increase the upward latency tolerance under circumstances where endpoint information indicates periodic endpoints. Additionally or alternatively, an apparatus may decrease the upward latency tolerance under circumstances where the endpoint information indicates bulk endpoints. In at least one embodiment, a value associated with LT_Active2 is larger than a value associated with LT_Active1.

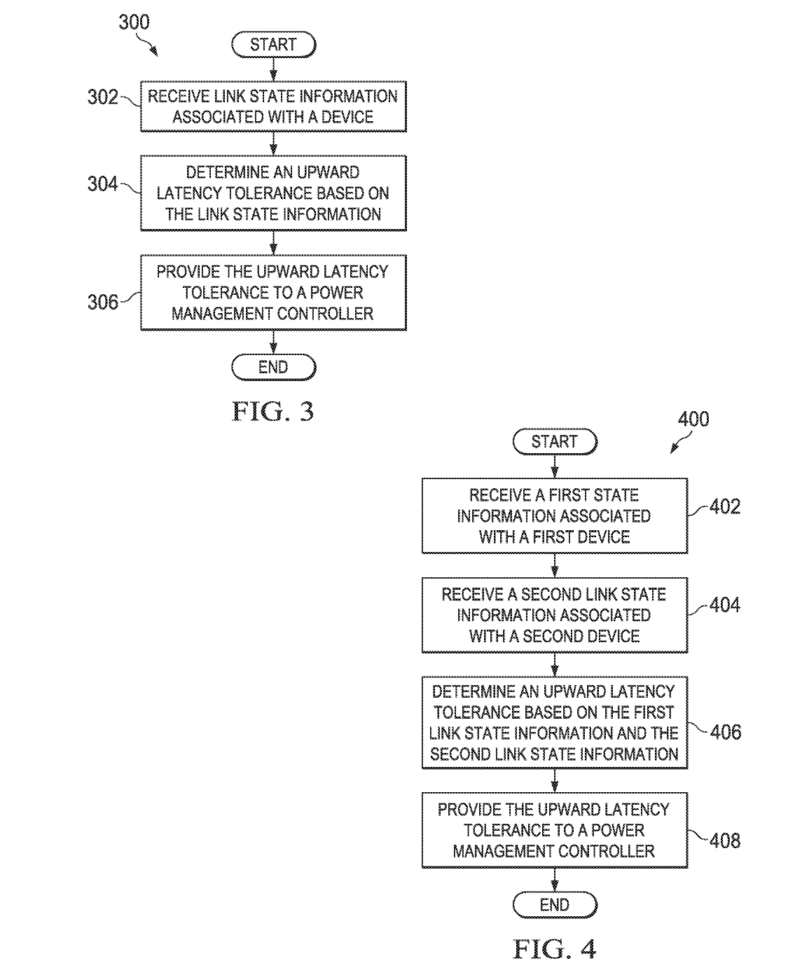

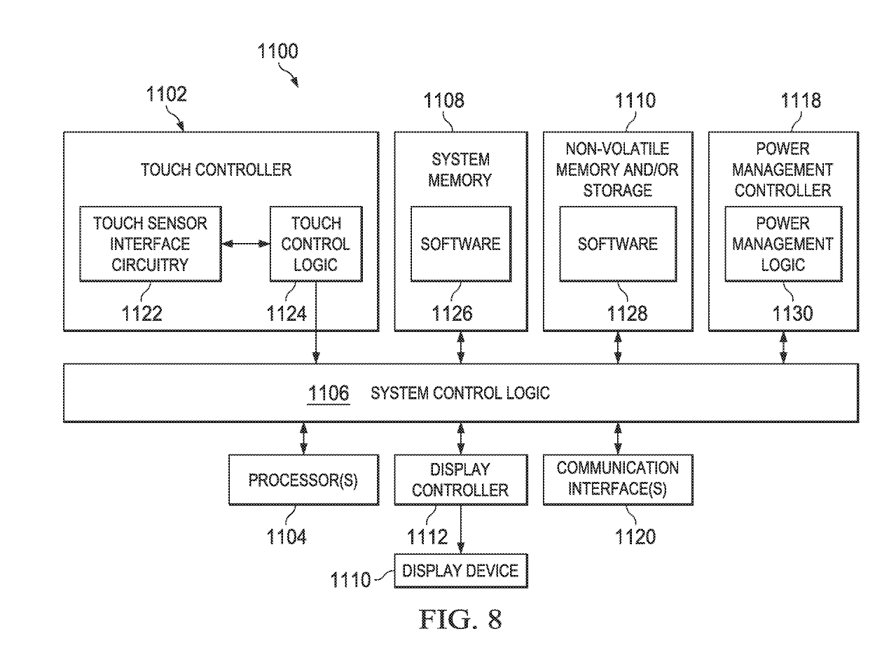

FIG. 3 is a flow diagram showing a set of operations 300 for providing an upward latency tolerance according to at least one example embodiment. An apparatus, for example system 1100 of FIG. 8 or a portion thereof, may utilize the set of operations 300. The apparatus may comprise means, including, for example processor 1104 of FIG. 8, for performing the operations of FIG. 3. In an example embodiment, an apparatus, for example system 1100 of FIG. 8, is transformed by having memory, for example system memory 1108 of FIG. 8, comprising computer code configured to, working with a processor, for example processor 1104 of FIG. 8, cause the apparatus to perform set of operations 300.

At block 302, the apparatus receives link state information associated with a device. The receiving of link state information may be similar as described regarding FIG. 1 and FIGS. 2A-2D. The link state information may be similar as described regarding FIGS. 2A-2D. At block 304, the apparatus determines an upward latency tolerance based on the link state information. Determination of the upward latency tolerance may be similar as described regarding FIG. 1 and FIGS. 2A-2D. At block 306, the apparatus provides the upward latency tolerance to a power management controller. Providing the upward latency tolerance may be similar as described regarding FIG. 1.

FIG. 4 is a flow diagram showing a set of operations 400 for providing an upward latency tolerance according to at least one example embodiment. An apparatus, for example system 1100 of FIG. 8 or a portion thereof, may utilize the set of operations 400. The apparatus may comprise means, including, for example processor 1104 of FIG. 8, for performing the operations of FIG. 4. In an example embodiment, an apparatus, for example system 1100 of FIG. 8, is transformed by having memory, for example system memory 1108 of FIG. 8, comprising computer code configured to, working with a processor, for example processor 1104 of FIG. 8, cause the apparatus to perform set of operations 400.

In at least one example embodiment, a controller may be in communication with more than one device. Under such circumstances, the controller may base the upward latency tolerance on the more than one device. The upward latency may be based on link state of one or more device, on a determined latency tolerance of one or more device, a latency tolerance communicated by one or more device (for example a USB 3.0 device), and/or the like. In such circumstances, the upward latency tolerance may indicate the smallest latency tolerance associated with a device.

At block 402, the apparatus receives first link state information associated with a first device, similar as described regarding block 302 of FIG. 3. At block 404, the apparatus receives second link state information associated with a second device, similar as described regarding block 302 of FIG. 3. At block 406, the apparatus determines an upward latency tolerance based, at least in part, on the first link state information and the second link state information. The determination may be similar as described regarding block 304 of FIG. 3. At block 408, the apparatus provides the upward latency tolerance to a power management controller, similar as described regarding block 306 of FIG. 3.

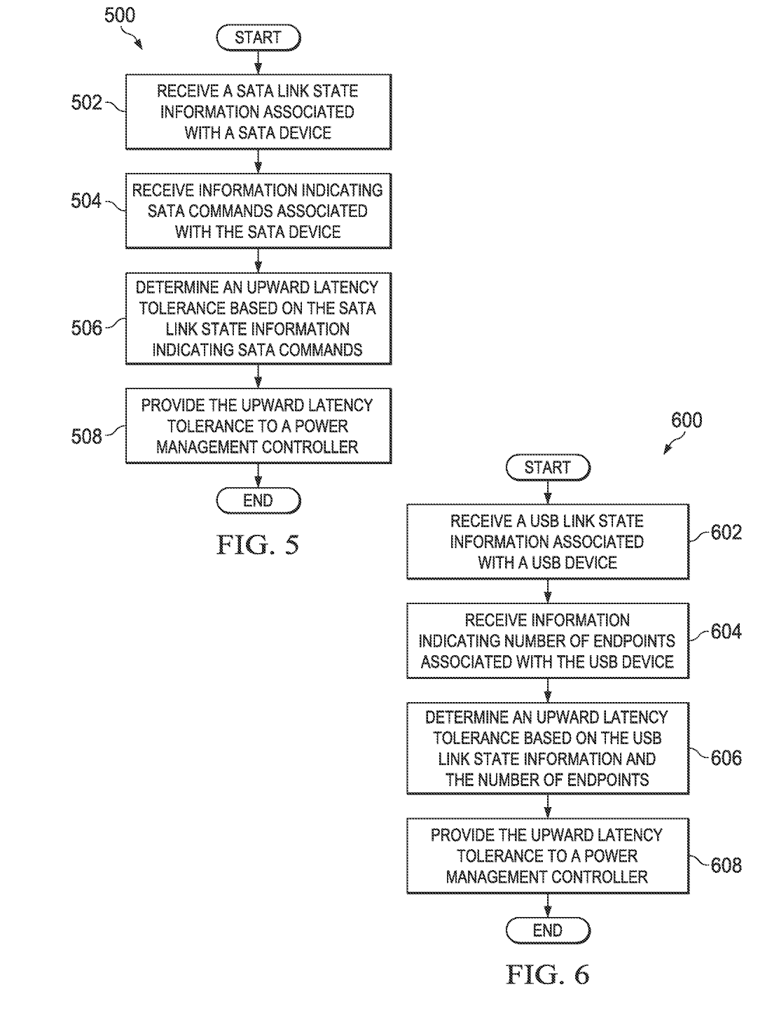

FIG. 5 is a flow diagram showing a set of operations 500 for providing an upward latency tolerance according to at least one example embodiment. An apparatus, for example system 1100 of FIG. 8 or a portion thereof, may utilize the set of operations 500. The apparatus may comprise means, including, for example processor 1104 of FIG. 8, for performing the operations of FIG. 5. In an example embodiment, an apparatus, for example system 1100 of FIG. 8, is transformed by having memory, for example system memory 1108 of FIG. 8, comprising computer code configured to, working with a processor, for example processor 1104 of FIG. 8, cause the apparatus to perform set of operations 500.

At block 502, the apparatus receives SATA link state information associated with a SATA device, similar as described regarding block 302 of FIG. 3. At block 504, the apparatus receives information indicating SATA commands associated with the SATA device, similar as described regarding FIGS. 2A-2B. The receiving may be similar as described regarding block 302 of FIG. 3. At block 506, the apparatus determines an upward latency tolerance based, at least in part, on the SATA link state information and the information indicating SATA commands. The determination may be similar as described regarding block 304 of FIG. 3. The determination may be similar as described regarding FIGS. 2A-2B. At block 508, the apparatus provides the upward latency tolerance to a power management controller, similar as described regarding block 306 of FIG. 3.

FIG. 6 is a flow diagram showing a set of operations 600 for providing an upward latency tolerance according to at least one example embodiment. An apparatus, for example system 1100 of FIG. 8 or a portion thereof, may utilize the set of operations 600. The apparatus may comprise means, including, for example processor 1104 of FIG. 8, for performing the operations of FIG. 6. In an example embodiment, an apparatus, for example system 1100 of FIG. 8, is transformed by having memory, for example system memory 1108 of FIG. 8, comprising computer code configured to, working with a processor, for example processor 1104 of FIG. 8, cause the apparatus to perform set of operations 600.

At block 602, the apparatus receives USB link state information associated with a USB device, similar as described regarding block 302 of FIG. 3. At block 604, the apparatus receives endpoint information associated with the USB device. At block 606, the apparatus determines an upward latency tolerance based, at least in part, on the USB link state information and the number of endpoints. The determination may be similar as described regarding block 304 of FIG. 3. At block 608, the apparatus provides the upward latency tolerance to a power management controller, similar as described regarding block 306 of FIG. 3.

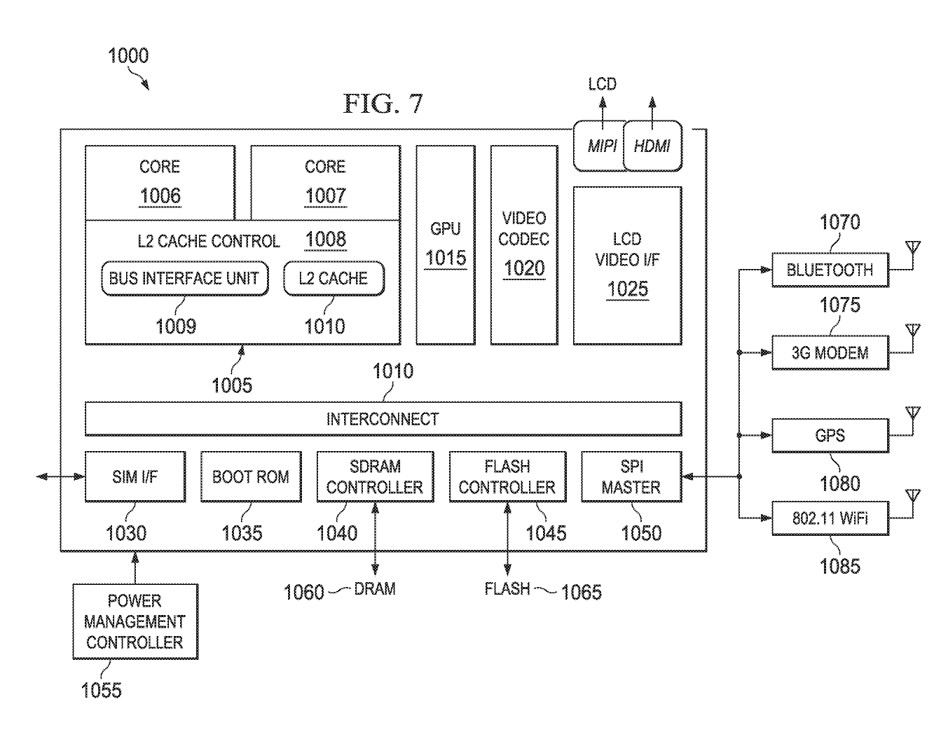

FIG. 7 is a simplified block diagram associated with an example ARM ecosystem SOC 1000 of the present disclosure. At least one example implementation of the present disclosure includes an integration of the power savings features discussed herein and an ARM component. For example, the example of FIG. 7 can be associated with any ARM core (e.g., A-9, A-15, etc.). Further, the architecture can be part of any type of tablet, smartphone (inclusive of Android™ phones, i-Phones™), i-Pad™, Google Nexus™, Microsoft Surface™, personal computer, server, video processing components, Ultrabook™ system, laptop computer (inclusive of any type of notebook), any type of touch-enabled input device, etc.

In this example of FIG. 7, ARM ecosystem SOC 1000 may include multiple cores 1006-1007, an L2 cache control 1008, a bus interface unit 1009, an L2 cache 1010, a graphics processing unit (GPU) 1015, an interconnect 1010, a video codec 1020, and a liquid crystal display (LCD) I/F 1025, which may be associated with mobile industry processor interface (MIPI)/high-definition multimedia interface (HDMI) links that couple to an LDC.

ARM ecosystem SOC 1000 may also include a subscriber identity module (SIM) I/F 1030, a boot read-only memory (ROM) 1035, a synchronous dynamic random access memory (SDRAM) controller 1040, a flash controller 1045, a serial peripheral interface (SPI) master 1050, a suitable power management controller 1055, a dynamic RAM (DRAM) 1060, and flash 1065. In addition, one or more example embodiment include one or more communication capabilities, interfaces, and features such as instances of Bluetooth 1070, a 3 G modem 1075, a global positioning system (GPS) 1080, and an 802.11 WiFi 1085.

In operation, the example of FIG. 7 can offer processing capabilities, along with relatively low power consumption to enable computing of various types (e.g., mobile computing, high-end digital home, servers, wireless infrastructure, etc.). In addition, such an architecture can enable any number of software applications (e.g., Android™, Adobe® Flash® Player, Java Platform Standard Edition (Java SE), JavaFX, Linux, Microsoft Windows Embedded, Symbian and Ubuntu, etc.). In at least one example embodiment, the core processor may implement an out-of-order superscalar pipeline with a coupled low-latency level-2 cache.

FIG. 8 is a simplified block diagram illustrating potential electronics and logic that may be associated with any of the power saving operations discussed herein. In at least one example embodiment, system 1100 includes a touch controller 1102, one or more processors 1104, system control logic 1106 coupled to at least one of processor(s) 1104, system memory 1108 coupled to system control logic 1106, non-volatile memory and/or storage device(s) 1110 coupled to system control logic 1106, display controller 1112 coupled to system control logic 1106, display controller 1112 coupled to a display, power management controller 1118 coupled to system control logic 1106, and/or communication interfaces 1120 coupled to system control logic 1106.

System control logic 1106, in at least one embodiment, includes any suitable interface controllers to provide for any suitable interface to at least one processor 1104 and/or to any suitable device or component in communication with system control logic 1106. System control logic 1106, in at least one example embodiment, includes one or more memory controllers to provide an interface to system memory 1108. System memory 1108 may be used to load and store data and/or instructions, for example, for system 1100. System memory 1108, in at least one example embodiment, includes any suitable volatile memory, such as suitable dynamic random access memory (DRAM) for example. System control logic 1106, in at least one example embodiment, includes one or more input/output (I/O) controllers to provide an interface to a display device, touch controller 1102, and non-volatile memory and/or storage device(s) 1110.

Non-volatile memory and/or storage device(s) 1110 may be used to store data and/or instructions, for example within software 1128. Non-volatile memory and/or storage device(s) 1110 may include any suitable non-volatile memory, such as flash memory for example, and/or may include any suitable non-volatile storage device(s), such as one or more hard disc drives (HDDs), one or more compact disc (CD) drives, and/or one or more digital versatile disc (DVD) drives for example.

Power management controller 1118 may include power management logic 1130 configured to control various power management and/or power saving functions disclosed herein or any part thereof. In at least one example embodiment, power management controller 1118 is configured to reduce the power consumption of components or devices of system 1100 that may either be operated at reduced power or turned off when the electronic device is in the closed configuration. For example, in at least one example embodiment, when the electronic device is in a closed configuration, power management controller 1118 performs one or more of the following: power down the unused portion of the display and/or any backlight associated therewith; allow one or more of processor(s) 1104 to go to a lower power state if less computing power is required in the closed configuration; and shutdown any devices and/or components, such as keyboard 108, that are unused when an electronic device is in the closed configuration.

Communications interface(s) 1120 may provide an interface for system 1100 to communicate over one or more networks and/or with any other suitable device. Communications interface(s) 1120 may include any suitable hardware and/or firmware. Communications interface(s) 1120, in at least one example embodiment, may include, for example, a network adapter, a wireless network adapter, a telephone modem, and/or a wireless modem.

System control logic 1106, in at least one example embodiment, includes one or more input/output (I/O) controllers to provide an interface to any suitable input/output device(s) such as, for example, an audio device to help convert sound into corresponding digital signals and/or to help convert digital signals into corresponding sound, a camera, a camcorder, a printer, and/or a scanner.

For at least one example embodiment, at least one processor 1104 may be packaged together with logic for one or more controllers of system control logic 1106. In at least one example embodiment, at least one processor 1104 may be packaged together with logic for one or more controllers of system control logic 1106 to form a System in Package (SiP). In at least one example embodiment, at least one processor 1104 may be integrated on the same die with logic for one or more controllers of system control logic 1106. For at least one example embodiment, at least one processor 1104 may be integrated on the same die with logic for one or more controllers of system control logic 1106 to form a System on Chip (SoC).

For touch control, touch controller 1102 may include touch sensor interface circuitry 1122 and touch control logic 1124. Touch sensor interface circuitry 1122 may be coupled to detect touch input over a first touch surface layer and a second touch surface layer of display 11 (i.e., display device 1110). Touch sensor interface circuitry 1122 may include any suitable circuitry that may depend, for example, at least in part, on the touch-sensitive technology used for a touch input device. Touch sensor interface circuitry 1122, in one embodiment, may support any suitable multi-touch technology. Touch sensor interface circuitry 1122, in at least one embodiment, includes any suitable circuitry to convert analog signals corresponding to a first touch surface layer and a second surface layer into any suitable digital touch input data. Suitable digital touch input data for one embodiment may include, for example, touch location or coordinate data.

Touch control logic 1124 may be coupled to help control touch sensor interface circuitry 1122 in any suitable manner to detect touch input over a first touch surface layer and a second touch surface layer. Touch control logic 1124 for at least one example embodiment may also be coupled to output in any suitable manner digital touch input data corresponding to touch input detected by touch sensor interface circuitry 1122. Touch control logic 1124 may be implemented using any suitable logic, including any suitable hardware, firmware, and/or software logic (e.g., non-transitory tangible media), that may depend, for example, at least in part on the circuitry used for touch sensor interface circuitry 1122. Touch control logic 1124 for one embodiment may support any suitable multi-touch technology.

Touch control logic 1124 may be coupled to output digital touch input data to system control logic 1106 and/or at least one processor 1104 for processing. At least one processor 1104 for one embodiment may execute any suitable software to process digital touch input data output from touch control logic 1124. Suitable software may include, for example, any suitable driver software and/or any suitable application software. As illustrated in FIG. 11, system memory 1108 may store suitable software 1126 and/or non-volatile memory and/or storage device(s).

Note that in some example implementations, the functions outlined herein may be implemented in conjunction with logic that is encoded in one or more tangible, non-transitory media (e.g., embedded logic provided in an application-specific integrated circuit (ASIC), in digital signal processor (DSP) instructions, software [potentially inclusive of object code and source code] to be executed by a processor, or other similar machine, etc.). In some of these instances, memory elements can store data used for the operations described herein. This includes the memory elements being able to store software, logic, code, or processor instructions that are executed to carry out the activities described herein. A processor can execute any type of instructions associated with the data to achieve the operations detailed herein. In one example, the processors could transform an element or an article (e.g., data) from one state or thing to another state or thing. In another example, the activities outlined herein may be implemented with fixed logic or programmable logic (e.g., software/computer instructions executed by a processor) and the elements identified herein could be some type of a programmable processor, programmable digital logic (e.g., a field programmable gate array (FPGA), a DSP, an erasable programmable read only memory (EPROM), electrically erasable programmable read-only memory (EEPROM)) or an ASIC that includes digital logic, software, code, electronic instructions, or any suitable combination thereof.

Note that with the examples provided above, as well as numerous other examples provided herein, interaction may be described in terms of layers, protocols, interfaces, spaces, and environments more generally. However, this has been done for purposes of clarity and example only. In certain cases, it may be easier to describe one or more of the functionalities of a given set of flows by only referencing a limited number of components. It should be appreciated that the architectures discussed herein (and its teachings) are readily scalable and can accommodate a large number of components, as well as more complicated/sophisticated arrangements and configurations. Accordingly, the examples provided should not limit the scope or inhibit the broad teachings of the present disclosure, as potentially applied to a myriad of other architectures.

It is also important to note that the blocks in the flow diagrams illustrate only some of the possible signaling scenarios and patterns that may be executed by, or within, the circuits discussed herein. Some of these blocks may be deleted or removed where appropriate, or these steps may be modified or changed considerably without departing from the scope of teachings provided herein. In addition, a number of these operations have been described as being executed concurrently with, or in parallel to, one or more additional operations. However, the timing of these operations may be altered considerably. The preceding operational flows have been offered for purposes of example and discussion. Substantial flexibility is provided by the present disclosure in that any suitable arrangements, chronologies, configurations, and timing mechanisms may be provided without departing from the teachings provided herein.

It is also imperative to note that all of the Specifications, protocols, and relationships outlined herein (e.g., specific commands, timing intervals, supporting ancillary components, etc.) have only been offered for purposes of example and teaching only. Each of these data may be varied considerably without departing from the spirit of the present disclosure, or the scope of the appended claims. The specifications apply to many varying and non-limiting examples and, accordingly, they should be construed as such. In the foregoing description, example embodiments have been described. Various modifications and changes may be made to such embodiments without departing from the scope of the appended claims. The description and drawings are, accordingly, to be regarded in an illustrative rather than a restrictive sense.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “step for” are specifically used in the particular claims; and (b) does not intend, by any statement in the Specification, to limit this disclosure in any way that is not otherwise reflected in the appended claims.

It should be understood that, even though various embodiments may be applicable to USB 3.0 standard, released November of 2008, other versions of this standard may be applicable. It should be understood that, even though various embodiments may be applicable to SATA revision 3.1 standard, released July of 2011, other versions of this standard may be applicable. It should be understood that, even though various embodiments may be applicable to AHCI 1.3 standard, released June of 2008, other versions of this standard may be applicable.

### Example Embodiment Implementations

One particular example implementation may include an apparatus that includes a means for receiving first link state information associated with a first device, a means for determining, by a processor, an upward latency tolerance based, at least in part, on the first link state information, and a means for providing the upward latency tolerance to a power management controller.

What is claimed is:

1. A method to determine a latency tolerance, comprising:
receiving first link state information associated with a first device;
determining an upward latency tolerance based, at least in part, on the first link state information; and
providing the upward latency tolerance to a power management controller.

2. The method of claim 1, further comprising:
determining a first latency tolerance based, at least in part, on the first link state information, wherein determining the upward latency tolerance is further based, at least in part, on the first latency tolerance.

3. The method of claim 1, further comprising:
receiving information indicating serial advanced technology attachment (SATA) commands associated with the first device, wherein determining the upward latency tolerance is further based, at least in part, on the information indicating SATA commands.

4. The method of claim 1, further comprising:
receiving second link state information associated with a second device, wherein determining the upward latency tolerance is further based, at least in part, on the second link state information.

5. The method of claim 4, wherein determining the upward latency tolerance based, at least in part, on the first link state information and the second link state information comprises determining a smaller of the first link state information and the second link state information.

6. The method of claim 1, wherein the first link state information relates to at least one of: a SATA link state or a USB link state.

7. The method of claim 1, wherein the first link state information relates to a USB link state, and further comprising receiving endpoint information associated with the first device, wherein the upward latency tolerance is further based, at least in part, on the endpoint information.

8. The method of claim 7, wherein determining the upward latency tolerance based, at least in part, on the first link state information and the endpoint information comprises decreasing the upward latency tolerance under circumstances in which at least one bulk endpoint is present.

9. An apparatus to determine latency tolerance comprising logic, the logic at least partially including hardware logic, to:
receive first link state information associated with a first device;
determine an upward latency tolerance based, at least in part, on the first link state information; and
provide the upward latency tolerance to a power management controller.

10. The apparatus of claim 9, further comprising logic, the logic at least partially including hardware logic, to determine a first latency tolerance based, at least in part, on the first link state information, wherein determination of the upward latency tolerance is further based, at least in part, on the first latency tolerance.

11. The apparatus of claim 9, further comprising logic, the logic at least partially including hardware logic, to receive information that indicates serial advanced technology attachment (SATA) commands associated with the first device, wherein determination of the upward latency tolerance is further based, at least in part, on the information that indicates SATA commands.

12. The apparatus of claim 9, further comprising logic, the logic at least partially including hardware logic, to receive second link state information associated with a second device, wherein determination of the upward latency tolerance is further based, at least in part, on the second link state information.

13. The apparatus of claim 12, wherein determination of the upward latency tolerance based, at least in part, on the first link state information and the second link state information comprises determination of a smaller of the first link state information and the second link state information.

14. The apparatus of claim 9, wherein the first link state information relates to at least one of: a SATA link state or a USB link state.

15. The apparatus of claim 9, wherein the first link state information relates to a USB link state, and further comprising logic, the logic at least partially including hardware logic, to receive endpoint information associated with the first device, wherein the upward latency tolerance is further based, at least in part, on the endpoint information.

16. The apparatus of claim 15, wherein determination of the upward latency tolerance based, at least in part, on the first link state information and the endpoint information comprises the upward latency tolerance being decreased under circumstances in which at least one bulk endpoint is present.

17. A non-transitory computer readable medium to determine latency tolerance comprising computer instructions, that, when executed by at least one processor, cause an apparatus comprising the processor to:
receive first link state information associated with a first device;
determine an upward latency tolerance based, at least in part, on the first link state information; and
provide the upward latency tolerance to a power management controller.

18. The computer readable medium of claim 17, wherein the computer readable medium further comprises computer instructions, that, when executed by at least one processor, further cause the apparatus comprising the processor to determine a first latency tolerance based, at least in part, on the first link state information, wherein determining the upward latency tolerance is further based, at least in part, on the first latency tolerance.

19. The computer readable medium of claim 17, wherein the computer readable medium further comprises computer instructions, that, when executed by at least one processor, further cause the apparatus comprising the processor to receive information indicating serial advanced technology attachment (SATA) commands associated with the first device, wherein determining the upward latency tolerance is further based, at least in part, on the information indicating SATA commands.

20. The computer readable medium of claim 17, wherein the computer readable medium further comprises computer instructions, that, when executed by at least one processor, further cause the apparatus comprising the processor to receive second link state information associated with a second device, wherein determining the upward latency tolerance is further based, at least in part, on the second link state information.

21. The computer readable medium of claim 20, wherein determining the upward latency tolerance based, at least in part, on the first link state information and the second link state information comprises determining a smaller of the first link state information and the second link state information.

22. The computer readable medium of claim 17, wherein the first link state information relates to at least one of: a SATA link state or a USB link state.

23. The computer readable medium of claim 17, wherein the first link state information relates to a USB link state, and wherein the computer readable medium further comprises computer instructions, that, when executed by at least one processor, further cause the apparatus comprising the processor to receive endpoint information associated with the first device, wherein the upward latency tolerance is further based, at least in part, on the endpoint information.

24. The computer readable medium of claim 23, wherein determining the upward latency tolerance based, at least in part, on the first link state information and the endpoint information comprises decreasing the upward latency tolerance under circumstances in which at least one bulk endpoint is present.

25. A system to determine a latency tolerance, comprising at least one controller, at least one power management controller, and at least one device comprising logic, the logic at least partially including hardware logic, to:
receive, at the controller, first link state information associated with a first device;
determine, at the controller, an upward latency tolerance based, at least in part, on the first link state information; and
provide, from the controller, the upward latency tolerance to the power management controller.

26. The system of claim 25, further comprising logic, the logic at least partially including hardware logic, to determine, at the controller, a first latency tolerance based, at least in part, on the first link state information, wherein determination of the upward latency tolerance is further based, at least in part, on the first latency tolerance.

27. The system of claim 25, further comprising logic, the logic at least partially including hardware logic, to receive, at the controller, information that indicates serial advanced technology attachment (SATA) commands associated with the first device, wherein determination of the upward latency tolerance is further based, at least in part, on the information that indicates SATA commands.

28. The system of claim 25, further comprising logic, the logic at least partially including hardware logic, to receive, at the controller, second link state information associated with a second device, wherein determination of the upward latency tolerance is further based, at least in part, on the second link state information.

29. The system of claim 25, wherein determination of the upward latency tolerance based, at least in part, on the first link state information and the second link state information comprises determination of a smaller of the first link state information and the second link state information.

30. The system of claim 25, wherein the first link state information relates to at least one of: a SATA link state or a USB link state.
